(19) United States
(12) Patent Application Publication
(10) Pub. No.: US 2018/0297099 A1
(43) Pub. Date: Oct. 18, 2018

(54) PUNCHING DEVICE

(71) Applicant: SMC CORPORATION, Chiyoda-ku (JP)

(72) Inventor: Hirotsugu NAGAI, Tsukubamirai-shi (JP)

(73) Assignee: SMC CORPORATION, Chiyoda-ku (JP)

(21) Appl. No.: 15/768,687

(22) PCT Filed: Oct. 24, 2016
(86) PCT No.: PCT/JP2016/004666

§ 371 Date: Apr. 16, 2018

(30) Foreign Application Priority Data
Nov. 4, 2015 (JP) 2015-216390

(51) Int. Cl. B21D 28/20; B21D 28/00; B30B 1/26; B30B 1/40

(52) U.S. Cl. CPC B21D 28/20; B30B 1/40; B30B 1/261; B21D 28/002

(57) ABSTRACT

A punching device includes a body, a drive unit connected to an upper part of the body, and a cam block that moves in a horizontal direction in the interior of the body under a driving action of the drive unit. A second rotating roller, which is connected to a rod, is inserted in a second cam groove of the cam block. The second cam groove includes first and second groove portions inclined at predetermined angles with respect to the direction of movement of the cam block, such that when the rod descends downwardly toward a workpiece, a second rotating roller moves from the second groove portion to the first groove portion having a smaller angle of inclination, whereby the driving force transmitted to the rod is boosted in power.

### TECHNICAL FIELD

The present invention relates to a punching device that pushes out a rod in an axial direction toward a workpiece under a driving action of a drive unit and punches a hole.

### BACKGROUND ART

As disclosed in Japanese Laid-Open Patent Publication No. 2014-205151, the present applicant has proposed a punching device for forming a hole by a punching process by pushing out a punch with respect to a sheet shaped object to be processed. In the punching device, a cam block is slidably disposed in the interior of a body, and a shaft of a drive unit, which is provided on a side portion of the body, is connected to the cam block. Further, a cam groove is formed in the cam block, and a rotating roller, which is provided on the end of a rod that is movable in a vertical direction, is inserted into the cam groove. In addition, by moving the cam block under a driving action of the drive unit, the rotating roller moves downwardly along the cam groove, and along therewith, by moving the rod vertically downward, a hole forming process is performed on the object to be processed by a punch that is mounted on the rod.

### SUMMARY OF INVENTION

A general object of the present invention is to provide a punching device which is capable of reducing the size of the device while also improving output.

The present invention is characterized by a punching device, comprising;

a body;

a drive unit having a drive shaft disposed in the body and which is displaced in an axial direction;

a rod disposed in parallel with a direction in which the drive shaft is displaced, and which is disposed displaceably with respect to the body; and

a driving force transmission mechanism having a slider displaceable in a direction substantially perpendicular to a direction of displacement of the drive shaft, and which transmits to the rod through the slider a driving force output by the drive unit;

wherein the slider includes:

a first inclined section, which is inclined with respect to the direction of displacement of the drive shaft, and with which an end of the drive shaft is engaged; and

a second inclined section, which is inclined with respect to the direction of displacement, and with which an end of the rod is engaged; and

further comprising a force boosting mechanism, which converts a transmission direction of the driving force into a substantially perpendicular direction by the first inclined section, and transmits the driving force to the slider, together with pressing the rod by the second inclined section under a displacement action of the slider, whereby the rod is displaced in the axial direction while boosting the driving force.

According to the present invention, in the driving force transmission mechanism of the punching device, the slider is included, which is displaceable in a direction substantially perpendicular to the direction of displacement of the drive shaft, and there are provided the first inclined section, which is inclined with respect to the direction of displacement of the drive shaft and with which an end of the drive shaft is engaged, and the second inclined section, which is inclined with respect to the direction of displacement and with which an end of the rod is engaged. The driving force transmission mechanism further comprises the force boosting mechanism, which converts a transmission direction of the driving force into a substantially perpendicular direction by the first inclined section, and transmits the driving force to the slider, together with pressing the rod by the second inclined section under a displacement action of the slider, whereby the rod is displaced in the axial direction while boosting the driving force.

Consequently, by having the first inclined section that converts the transmission direction of the driving force of the drive unit, since the drive unit can be arranged in a substantially perpendicular direction to the direction of displacement of the slider, the widthwise or transverse dimension of the punching device in the direction of displacement of the slider can be reduced in size, and the output applied to the rod can be enhanced by the power boosting mechanism.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF DRAWINGS

FIG. 1 is an overall cross-sectional view of a punching device according to an embodiment of the present invention;

FIG. 2 is an exploded perspective view of the punching device shown in FIG. 1;

FIG. 3 is a cross-sectional view taken along line III-III of FIG. 1; and

FIG. 4 is an overall cross-sectional view showing a condition in which a drive unit of the punching device of FIG. 1 is driven, a rod is pushed out in a downward direction, and machining is carried out on a workpiece.

### DESCRIPTION OF EMBODIMENTS

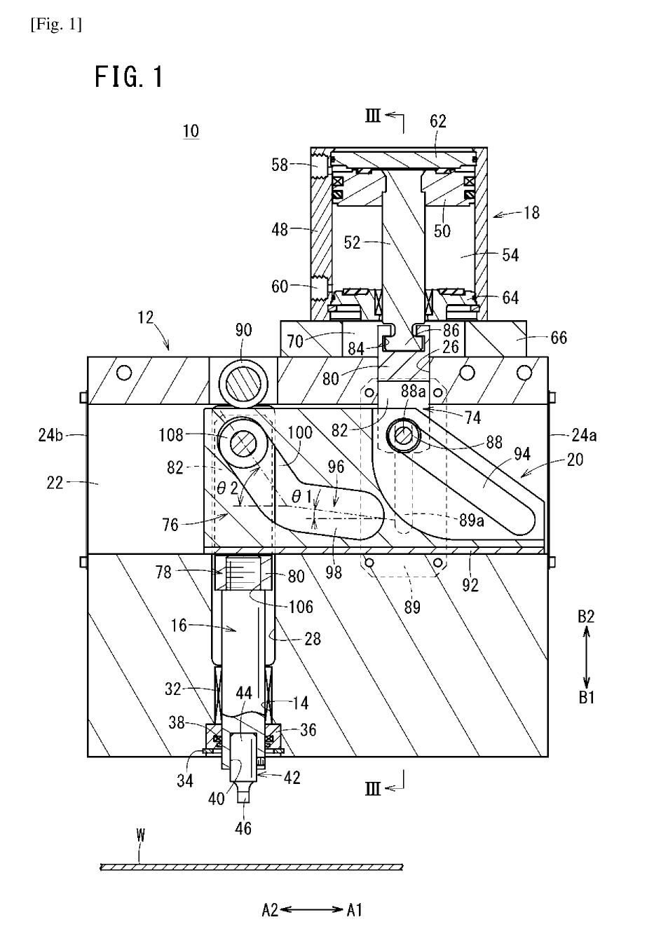

As shown in FIGS. 1 through 4, the punching device 10 includes a body 12, a rod 16 disposed displaceably along a penetrating hole 14 of the body 12, a drive unit 18 that drives the rod 16, and a driving force transmission mechanism 20 that increases a driving force from the drive unit 18 and transmits the driving force to the rod 16.

The body 12 is in the shape of a block having a rectangular shape in cross section, and for example, is fixed to a transport path on which the punching device 10 is mounted, and a first accommodating hole 22 is formed therein that extends in a horizontal direction (directions pointed by arrows A1, A2) in a substantially central portion along the height direction thereof. The first accommodating hole 22 is formed with a rectangular shape in cross section, and both opened ends thereof are closed by cover members 24a, 24b that are mounted on side surfaces of the body 12.

Further, an opening 26 that is rectangular in cross section is formed on an upper part on one end side (in the direction of the arrow A1) of the body 12. The opening 26 extends in a penetrating manner in a vertical downward direction (in the direction of the arrow B1) to the first accommodating hole 22.

Furthermore, a second accommodating hole 28 with a rectangular shape in cross section, and which extends in the vertical direction (the direction of arrows B1 and B2) perpendicularly to the first accommodating hole 22, is formed in the body 12. The second accommodating hole 28 is formed at a position on the other end side (the direction of arrow A2) from the center along the longitudinal direction (the direction of arrows A1 and A2) of the first accommodating hole 22, is formed to cross the first accommodating hole 22, and an upper end thereof opens on an upper portion of the body 12.

Furthermore, a lower end of the second accommodating hole 28 extends at a predetermined height from a lower portion of the body 12 to a position inside the body 12 (to the side of the first accommodating hole 22), and on the lower end thereof, a penetrating hole 14 is formed that extends to the lower portion of the body 12. The penetrating hole 14 is formed with a circular shape in cross section, and penetrates to the lower portion of the body from the bottom of the second accommodating hole 28. More specifically, the second accommodating hole 28 and the penetrating hole 14 are formed on a straight line along a vertical direction (the direction of arrows B1 and B2).

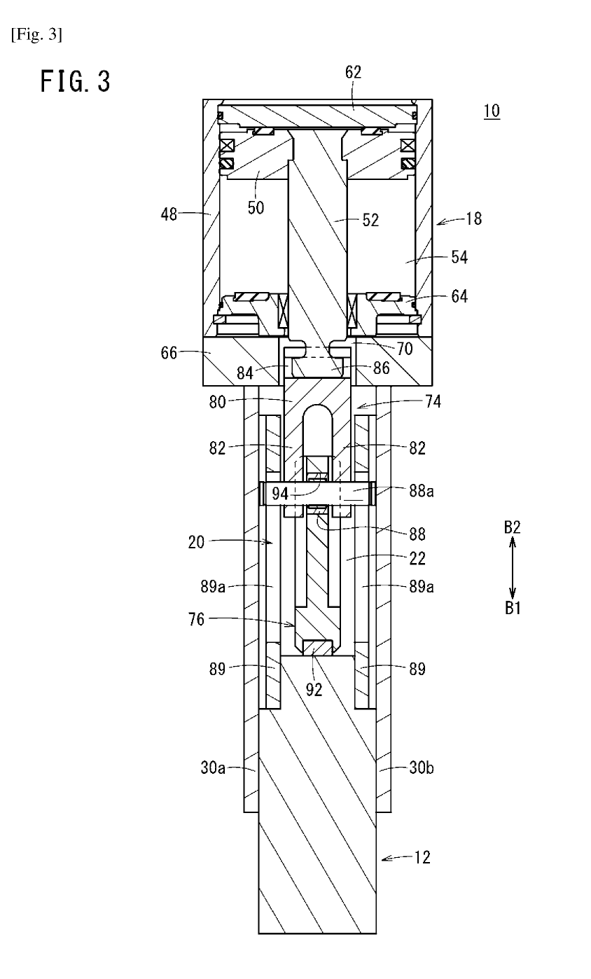

Further, in a state in which the driving force transmission mechanism 20, etc., is accommodated in the interior of the body 12, body covers 30a, 30b are mounted on body side surfaces of the body 12 to thereby close the side surfaces (see FIG. 3).

The rod 16, for example, is made up from a substantially uniform diameter shaft body, which is inserted through the second accommodating hole 28 and the penetrating hole 14, and is disposed displaceably in the axial direction (the direction of arrows B1 and B2) by a bush 32 provided in the interior of the penetrating hole 14.

Moreover, in the opening of the penetrating hole 14 on the downward side of the body 12, a covering 36 is disposed through a locking ring 34. A packing 38 disposed on an inner circumferential surface of the covering 36 slides along an outer circumferential surface of the rod 16, whereby the opening is closed and ingress of dust or the like from the exterior is prevented.

Further, a distal end of the rod 16 projects downwardly (in the direction of the arrow B1) a predetermined length at all times from the covering 36 and the lower portion of the body 12, and a mounting hole 40, in which a later-described attachment 42 is mounted, is formed in the center of the rod 16.

The attachment 42 includes a shaft portion 44 formed on a proximal end side thereof (in the direction of the arrow B2) and which is inserted in the mounting hole 40, and a machining part 46 formed on a distal end side thereof (in the direction of arrow B1) and which has a circular shape in cross section which is reduced in diameter with respect to the shaft portion 44, and having a blade or cutting member on its end. In addition, the attachment 42 is fixed to a distal end of the rod 16 by a set screw, in a state in which the shaft portion 44 is inserted in the mounting hole 40 and the machining part 46 projects downwardly.

The drive unit 18, for example, is a fluid pressure cylinder driven under the supply of a pressure fluid, which is disposed so as to extend vertically upward (in the direction of the arrow B2) with respect to the upper portion of the body 12. The drive unit 18 includes a cylinder tube 48 formed in a tubular shape, a piston 50 provided displaceably in the interior of the cylinder tube 48, and a piston rod (drive shaft) 52 connected to the piston 50 and which transmits a driving force to the driving force transmission mechanism 20.

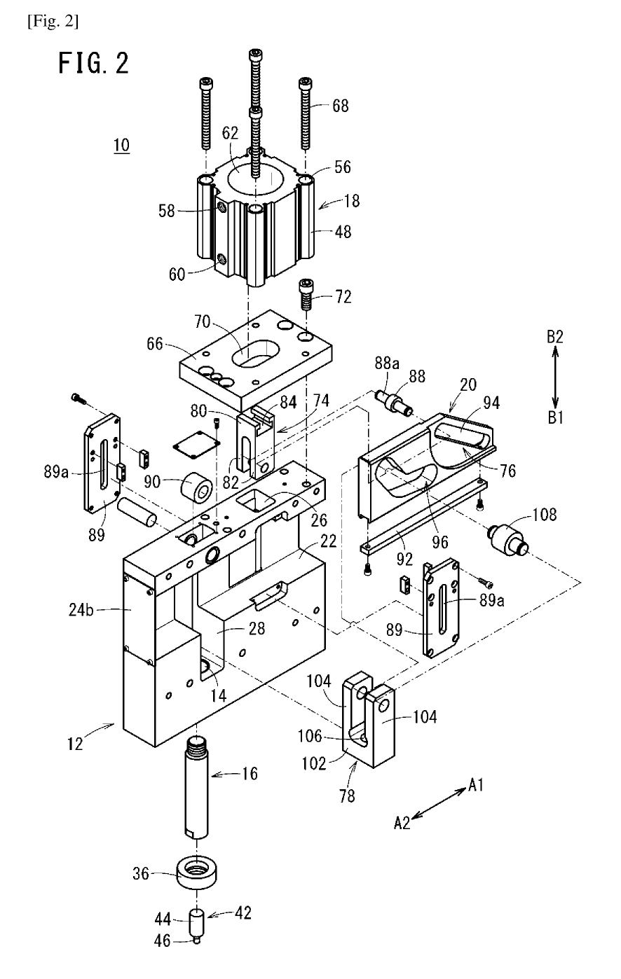

The cylinder tube 48 has a cylinder hole 54 formed therein that penetrates through the center of the cylinder tube 48 along the axial direction (the direction of arrows B1, B2). As shown in FIG. 2, bolt holes 56 that penetrate in the axial direction are formed respectively in four corners on the outer peripheral sides of the cylinder hole 54.

Further, first and second ports 58, 60 for supplying and discharging a pressure fluid are formed on an outer peripheral part of the cylinder tube 48. Non-illustrated pipes are connected to the first and second ports 58, 60, and communicate respectively with the cylinder hole 54. The first port 58 is disposed on one end side (in the direction of the arrow B2) of the cylinder tube 48, whereas the second port 60 is disposed on another end side (in the direction of the arrow B1) of the cylinder tube 48.

A head cover 62 is mounted on one end of the cylinder tube 48, and a rod cover 64 is mounted on the other end thereof so as to close the cylinder hole 54. In addition, in a state in which a base plate 66 formed from a substantially rectangular plate abuts against the other end of the cylinder tube 48, fastening bolts 68, which are inserted through bolt holes 56 from the one end side of the cylinder tube 48, are screw-engaged and connected to the base plate 66.

The piston 50 is disposed displaceably in the axial direction (the direction of arrows B1 and B2) in the interior of the cylinder hole 54 between the head cover 62 and the rod cover 64. One end of the piston rod 52 is caulked and connected in the center of the piston 50.

In addition, the other end side of the piston rod 52 is movably supported along the axial direction by being inserted through the interior of the rod cover 64, together with projecting out to the exterior from the other end of the cylinder tube 48, and being connected to a later-described first displaceable body 74.

A through hole 70 having an elliptical shape in cross section, for example, is formed substantially in the center of the base plate 66. The piston rod 52 is inserted movably through the interior of the through hole 70, together with the later-described first displaceable body 74 also being inserted movably.

Further, the base plate 66 is disposed in facing relation to the opening 26 that opens on the upper portion of the body 12, and at a position in which the opening 26 and the through hole 70 are on a straight line, the base plate 66 is fixed with respect to the upper portion of the body 12 by a plurality of fixing bolts 72 (see FIG. 2). Consequently, in a state in which the through hole 70 and the opening 26 communicate with each other, the drive unit 18 is fixed in a perpendicular manner on the upper portion of the body 12 through the base plate 66.

The driving force transmission mechanism 20 includes a first displaceable body 74 connected to the other end of the piston rod 52, a cam block (slider) 76 movably disposed in the first accommodating hole 22 of the body 12, and a second displaceable body 78 connected to a proximal end of the rod 16.

The first displaceable body 74 comprises a bridge portion 80, which is accommodated in the first accommodating hole 22 through the opening 26 of the body 12, and to which a connecting part 86 of the piston rod 52 is connected, and yoke portions 82 that project downwardly and perpendicularly in a bifurcated manner from both ends of the bridge portion 80. A groove 84 that penetrates in a horizontal direction with a rectangular shape in cross section is included in the bridge portion 80, and by insertion of the connecting part 86 of the piston rod 52 in a horizontal direction with respect to the groove 84, the connecting part 86 engages with the groove 84, and a connected state is brought about in which relative displacement in the axial direction is regulated.

Further, the yoke portions 82 extend in a direction away from the piston rod 52, i.e., in a downward direction (the direction of the arrow B1), and one end side of the cam block 76 is inserted through an inside area between the yoke portions 82 which are separated mutually by a predetermined interval, together with rotating shafts 88a of a first rotating roller 88 being pivotally supported with respect to pin holes that are formed in ends of the yoke portions 82.

Furthermore, ends of the rotating shafts 88a of the first rotating roller 88 are inserted respectively through slits 89a of cam covers 89 that are mounted on both side surfaces of the body 12, whereby the first rotating roller 88 is regulated so as to be movable only in the vertical direction (the direction of arrows B1 and B2).

In addition, by the connecting part 86 of the piston rod 52 being connected to the bridge portion 80, the first displaceable body 74 is freely movable in the vertical direction (the direction of arrows B1 and B2) integrally with the piston rod 52 in the first accommodating hole 22 and the opening 26 of the body 12.

The cam block 76, for example, is formed in a block-like shape with a substantially elongate shape in cross section, with one end thereof being formed more thinly than the other end. A support roller 90, which is disposed rotatably on an upper part of the second accommodating hole 28, abuts against an upper surface of the cam block 76, and serves to guide the cam block 76 along the first accommodating hole 22 when the cam block 76 moves in the horizontal direction (the direction of arrows A1 and A2).

Further, when the second displaceable body 78 and the rod 16 are lowered and machining of a workpiece W (see FIG. 1) is carried out, a counterforce is applied from the workpiece W in a vertical upward direction (in the direction of the arrow B2) with respect to the second displaceable body 78 and the rod 16, and the support roller 90 functions as a stopper that is capable of preventing the cam block 76 from being pressed upwardly (in the direction of the arrow B2) by such a counterforce.

On the other hand, a thin plate-shaped bearing member 92 is installed on the bottom surface of the cam block 76. The bearing member 92 abuts against the bottom wall surface of the first accommodating hole 22. The bearing member 92, for example, is formed by a material with a low coefficient of friction and is coated with a lubricant on the surface thereof. The bearing member 92 guides the cam block 76 smoothly along the bottom wall surface of the first accommodating hole 22.

Further, as shown in FIGS. 1 and 2, in the cam block 76, there are included a first cam groove (first inclined section) 94 formed in a straight line shape on one end side, and a second cam groove (second inclined section) 96 formed substantially with a V-shape in cross section on the other end side thereof. The first and second cam grooves 94, 96 are formed with constant widths, respectively, that penetrate in the thickness direction. The first cam groove 94 is disposed on a thin-walled region of the cam block 76, whereas the second cam groove 96 is disposed on a thick-walled region of the cam block 76.

The first cam groove 94 extends in a slanted orientation inclined at a predetermined angle, such that one end thereof is located in the vicinity of the bottom surface of the cam block 76, and the other end is located in the vicinity of the upper surface of the cam block 76. The first rotating roller 88, which is pivotally supported in the first displaceable body 74, is inserted into the interior of the first cam groove 94.

Stated otherwise, the first cam groove 94 is formed in a straight line shape from a lower location to an upper location and from one end to the other end of the cam block 76.

The second cam groove 96 includes on one end side thereof (in the direction of the arrow A1) a first groove portion 98 formed on the bottom surface side, and a second groove portion 100 that is joined to the first groove portion 98 and extends gradually upward (in the direction of the arrow B2) toward the other end side (in the direction of the arrow A2).

One end of the first groove portion 98 is disposed at substantially the same height as the one end of the first cam groove 94, and the first groove portion 98 is inclined upwardly (in the direction of the arrow B2) at a first angle of inclination θ1 (see FIG. 1) from the one end toward the other end side (in the direction of the arrow A2). The second groove portion 100 is inclined upwardly (in the direction of the arrow B2) with respect to the first groove portion 98 at an even larger second angle of inclination θ2 (see FIG. 1) toward the other end side (in the direction of the arrow A2). The first and second angles of inclination θ1, θ2 are angles of inclination with respect to the horizontal direction (the direction of arrows A1 and A2), which defines the direction of displacement of the cam block 76.

More specifically, the second cam groove 96 is formed in a stepped shape from the first and second groove portions 98, 100 having different angles of inclination. In addition, a second rotating roller 108, which is pivotally supported in a later-described second displaceable body 78, is inserted into the second cam groove 96.

The second displaceable body 78 comprises a bridge portion 102, which is accommodated movably along the second accommodating hole 28 of the body 12, and to which a proximal end part of the rod 16 is connected, and yoke portions 104 that project upwardly (in the direction of the arrow B2) and perpendicularly in a bifurcated manner from both ends of the bridge portion 102. As shown in FIG. 1, a connecting hole 106, which extends in an axial direction and with which the rod 16 is screw-engaged, is included in the bridge portion 102, and the rod 16 and the second displaceable body 78 are connected in a straight line through the connecting hole 106.

Further, the yoke portions 104 extend in a direction away from the rod 16, i.e., in an upward direction (the direction of the arrow B2), and another end side of the cam block 76 is inserted through an inside area between the yoke portions 104, which are separated mutually by a predetermined interval, together with a second rotating roller 108 being pivotally supported rotatably with respect to pin holes that are formed in ends of the yoke portions 104. The second rotating roller 108 is inserted into the second cam groove 96 of the cam block 76 that is inserted between the yoke portions 104.

In addition, by the proximal end part of the rod 16 being connected to the bridge portion 102, the second displaceable body 78 is freely movable in the vertical direction (the direction of arrows B1 and B2) integrally with the rod 16 along the second accommodating hole 28 of the body 12, and together therewith, the rod 16 is freely movable in the second accommodating hole 28 and the penetrating hole 14.

The punching device 10 according to the embodiment of the present invention is constructed basically as described above. Next, operations and effects of the punching device 10 will be described. In the following description, the condition shown in FIG. 1, in which the piston 50 of the drive unit 18 is moved to the side of the head cover 62 (in the direction of the arrow B2), will be described as an initial position. In addition, a description will be given concerning a case in which a hole-opening process is performed at a predetermined position of the workpiece W by the attachment 42 that is mounted on the rod 16.

In the initial position, a condition is brought about in which a workpiece W is placed downwardly (in the direction of the arrow B1) of the attachment 42 that is mounted on the rod 16, and the workpiece W is positioned at a machining site where hole-opening is desired to be performed at a position on a straight line with the attachment 42. In this state, a pressure fluid is supplied to the first port 58 through a pipe from a non-illustrated pressure fluid supply source. Consequently, by the pressure fluid that is introduced into the cylinder hole 54, the piston 50 moves along the cylinder tube 48 to the side of the rod cover 64 (the direction of arrow B1), accompanied by the piston rod 52 being moved downwardly together with the first displaceable body 74. Further, in this case, the second port 60 is placed in a state of being open to atmosphere.

In addition, by the first rotating roller 88, which is supported on the first displaceable body 74, descending along the first cam groove 94, the cam block 76 is pressed and begins to move along the first accommodating hole 22 toward the other end side (in the direction of the arrow A2) of the body 12. More specifically, a thrust force (driving force) of the drive unit 18 in a vertical downward direction is converted into a horizontally directed thrust force of the cam block 76, and is transmitted to the cam block 76.

At this time, the cam block 76 is displaced smoothly and highly accurately along the bottom wall surface of the first accommodating hole 22 by the bearing member 92 that is installed on the bottom surface thereof, and together therewith, the rod 16 is guided with high precision in a vertical downward direction (the direction of the arrow B1) by the bush 32 that is disposed on the outer circumferential side of the rod 16.

Accompanying movement of the cam block 76, the second rotating roller 108, which is positioned at the end of the second groove portion 100 in the second cam groove 96, is pressed downward, and from the state shown in FIG. 1, the second displaceable body 78 that is held by the second rotating roller 108 and the rod 16 begin to descend in an integral fashion. More specifically, a thrust force that is applied to the cam block 76 in a horizontal direction (the direction of the arrow A2) is once again converted into a vertical downward direction (in the direction of the arrow B1), and is transmitted with respect to the second displaceable body 78 and the rod 16 by the second rotating roller 108 that is engaged with the second cam groove 96.

In addition, the cam block 76 is moved to the other end side (in the direction of the arrow A2) of the body 12 under the driving action of the drive unit 18. Accordingly, the second displaceable body 78 and the rod 16 descend further, whereupon the machining part 46 of the attachment 42 approaches toward the side of the workpiece W, and the machining part 46 comes into abutment against the surface of the workpiece W. Together therewith, the second rotating roller 108 moves from the second groove portion 100 into the first groove portion 98, and because the first groove portion 98 has a smaller angle of inclination than the second groove portion 100 (θ1<θ2), the driving force (output) applied to the second displaceable body 78 and the rod 16 and which is transmitted vertically downward (the direction of arrow B1) becomes greater in value. More specifically, compared to the case in which the second rotating roller 108 is engaged with the second groove portion 100, the driving force that is transmitted vertically downward is boosted in power.

Stated otherwise, in the second cam groove 96, the first groove portion 98 in which the second rotating roller 108 moves functions as a power boosting mechanism for boosting the driving force that is applied to the second displaceable body 78, the rod 16, and the attachment 42, while in addition, the movement distance of the second rotating roller 108 in the interior of the first groove portion 98 defines a power boosting range in which power is boosted.

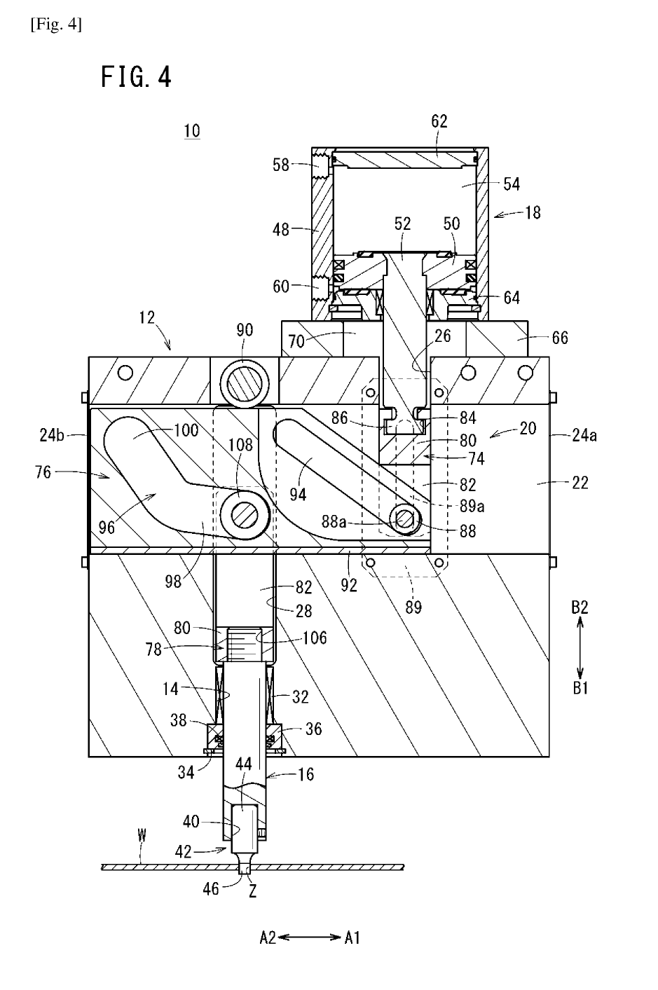

In addition, by further driving the drive unit 18 in the state in which the driving force thereof is boosted, the second rotating roller 108 moves toward the end of the first groove portion 98, and as shown in FIG. 4, via the rod 16, the machining part 46 of the attachment 42 punches a predetermined location of the workpiece W, and a predetermined punch hole Z with a circular cross-sectional shape is formed in the workpiece W.

During the process from abutment of the attachment 42 against the surface of the workpiece W and until punching takes place, a counterforce is applied from the workpiece W to the attachment 42 in an opposite direction (the direction of the arrow B2) to the pressing direction, and the counterforce is transmitted to the cam block 76 through the rod 16 and the second displaceable body 78. However, since upward movement (in the direction of the arrow B2) of the cam block 76 is restricted by the support roller 90 that is in abutment against the upper surface of the cam block 76, the cam block 76 is maintained in a predetermined position without being moved by the counterforce. As a result, even in the case that such a counterforce is applied with respect to the cam block 76, the cam block 76 can be displaced with a high degree of accuracy along the first accommodating hole 22.

As shown in FIG. 4, after the punch hole Z has been formed at a predetermined position of the workpiece W, under a switching action of a non-illustrated switching device, the pressure fluid that had been supplied to the first port 58 is supplied instead to the second port 60. Further, in this case, the first port 58 is placed in a state of being open to atmosphere.

Consequently, the pressure fluid is supplied between the piston 50 and the rod cover 64, whereupon the piston 50 is pressed toward the side of the head cover 62 (in the direction of the arrow B2). Along therewith, by the piston rod 52 and the first displaceable body 74 moving in the upward direction, and the first rotating roller 88 being pulled upwardly along the first cam groove 94, the cam block 76 moves along the first accommodating hole 22 toward the one end side (in the direction of the arrow A1) of the body 12.

At the same time, the second rotating roller 108, which is inserted through the second cam groove 96, moves from the first groove portion 98 into the second groove portion 100, whereupon the second displaceable body 78 and the rod 16 are pulled upward (in the direction of the arrow B2), and along therewith, the attachment 42 is pulled out upwardly from the punch hole Z of the workpiece W. By the cam block 76 being moved to the one end side of the body 12 (in the direction of the arrow A1) under the driving action of the drive unit 18, the second rotating roller 108 is moved to the end of the second groove portion 100, and as shown in FIG. 1, the initial position in which the first and second displaceable bodies 74, 78 and the rod 16 are moved upwardly (in the direction of the arrow B2) is restored.

As described above, according to the present embodiment, the drive unit 18 is provided on the upper portion of the body 12 that makes up the punching device 10, together with the cam block 76 being provided that moves horizontally along the first accommodating hole 22 of the body 12, and the first rotating roller 88, which is supported in the first displaceable body 74 connected to the piston rod 52 of the drive unit 18, being engaged with the first cam groove 94 of the cam block 76 that extends in an inclined orientation. Thus, the driving force of the drive unit 18 can be converted into a thrust force in a horizontal direction of the cam block 76 and transmitted to the cam block 76.

In this manner, by providing the drive unit 18 on the upper portion of the body 12, compared to the conventional punching device in which the drive unit is disposed on one end of the body, the longitudinal direction (transverse direction) of the body 12 can be reduced in size. Therefore, it is possible for the punching device 10 to easily be installed, even in the case that the available space in the longitudinal direction in the installation environment for the punching device 10 is restricted.

Further, by constituting the second cam groove 96 of the cam block 76 from the first groove portion 98, which has a small first angle of inclination θ1 with respect to the direction of movement (the direction of arrows A1 and A2) of the cam block 76, and the second groove portion 100, which has a larger second angle of inclination 02, in a state in which the second rotating roller 108 of the second displaceable body 78 connected to the rod 16 is engaged with the second cam groove 96, by the second rotating roller 108 moving from the second groove portion 100 into the first groove portion 98 under the driving action of the drive unit 18, the output that is imparted in a vertical downward direction (the direction of arrow B1), i.e., toward the side of the workpiece W, with respect to the second displaceable body 78 and the rod 16 can be boosted in power. As a result, the driving force that is output by the drive unit 18 is boosted in power by the driving force transmission mechanism 20, and machining of the workpiece W can be carried out by transmitting the boosted driving force to the rod 16.

Furthermore, even if the driving force output by the drive unit 18 is small, the workpiece W can be machined at a desired output by boosting the driving force through the driving force transmission mechanism 20, and transmitting the boosted driving force to the rod 16. Therefore, for example, even in the case that a large output is required, such a need can be handled with a drive unit 18 having a small output, and it is possible for the punching device 10 to be made even smaller in scale.

Furthermore, since the fluid pressure cylinder that makes up the drive unit 18 can freely be attached and detached by screw-rotating the fastening bolts 68, desired outputs responsive to the shapes and types, etc., of workpieces W to be machined by the punching device 10 can be handled by simply replacing the drive unit 18 with another drive unit 18. Therefore, by suitably exchanging the drive unit 18, it is possible to perform machining of various workpieces W requiring different output conditions with a single punching device, without the need to prepare multiple punching devices equipped with drive units 18 having different outputs.

Further, by suitably modifying the first angle of inclination 01 or the length in the axial direction (the direction of arrows A1 and A2) of the first groove portion 98 in the second cam groove 96, the power boosting range or the degree of boosting can freely be set.

Furthermore, with the above-described punching device 10, a description was given of a case in which the first cam groove 94 of the cam block 76 is formed in a linear shape. However, for example, by forming the first cam groove 94 substantially with a V-shape in cross section in the same manner as the second cam groove 96, it becomes possible for the thrust force obtained through the first cam groove 94 in the horizontal direction of the cam block 76 to be boosted in power. As a result, since it is possible for the driving force of the drive unit 18 to be boosted respectively by the first and second cam grooves 94, 96, compared to the case of being boosted only by the second cam groove 96, the degree of boosting can be made greater, thus enabling compatibility even with a drive unit 18 having a small output capability, and it is possible for the device to be made even smaller in scale.

The punching device according to the present invention is not limited to the embodiment described above, and various modified or additional configurations may be adopted therein without departing from the essential scope of the present invention as set forth in the appended claims.

1. A punching device comprising;
a body;
a drive unit having a drive shaft disposed in the body and which is displaced in an axial direction;
a rod disposed in parallel with a direction in which the drive shaft is displaced, and which is disposed displaceably with respect to the body; and
a driving force transmission mechanism having a slider displaceable in a direction substantially perpendicular to a direction of displacement of the drive shaft, and which transmits to the rod through the slider a driving force output by the drive unit;
wherein the slider includes:
a first inclined section, which is inclined with respect to the direction of displacement of the drive shaft, and with which an end of the drive shaft is engaged; and
a second inclined section, which is inclined with respect to the direction of displacement, and with which an end of the rod is engaged; and
further comprising a force boosting mechanism, which converts a transmission direction of the driving force into a substantially perpendicular direction by the first inclined section, and transmits the driving force to the slider, together with pressing the rod by the second inclined section under a displacement action of the slider, whereby the rod is displaced in the axial direction while boosting the driving force.

2. The punching device according to claim 1, wherein the first and second inclined sections are defined by cam grooves formed in the slider and in which rollers are inserted, at least one of the first and second inclined sections including a second groove portion inclined with respect to the direction of displacement, and a first groove portion joined to the second groove portion and having a smaller angle of inclination than the second groove portion.
